(19) United States
(12) Patent Application Publication
(10) Pub. No.: US 2022/0104550 A1
(43) Pub. Date: Apr. 7, 2022

(54) ATOMIZATION SHEET FOR ELECTRONIC CIGARETTE AND ATOMIZER

(71) Applicant: O-NET AUTOMATION TECHNOLOGY (SHENZHEN) LIMITED, Shenzhen, Guangdong (CN)

(72) Inventors: Aimin Mao, Shenzhen, Guangdong (CN); Meiling Guo, Shenzhen, Guangdong (CN); Huihua Huang, Shenzhen, Guangdong (CN); Bo Zhou, Shenzhen, Guangdong (CN)

(21) Appl. No.: 17/420,716

(22) PCT Filed: Jan. 10, 2019
(86) PCT No.: PCT/CN2019/071215

§ 371 Date: Jul. 5, 2021

(51) Int. Cl. A24F 40/46; A24F 40/485; A24F 40/10; H05B 3/22

(52) U.S. Cl. CPC A24F 40/46; A24F 40/485; H05B 2203/021; H05B 3/22; A24F 40/10

(57) ABSTRACT

An atomization sheet for an electronic cigarette and an atomizer. The atomization sheet includes a sheet-shaped atomization sheet body having a surface in contact connection with a liquid transfer member, and a hole portion defined in the atomization sheet body. The hole portion extends through two opposite surfaces of the atomize sheet body. The sheet-shaped atomization sheet body is in better contact with the liquid transfer member for liquid transfer and atomizing, the contact area between the atomization sheet body and the liquid transfer member is large, thus the atomization area is large. The resistance value of the atomization sheet is adjusted through the arrangement of the hole portion of the atomization sheet, so that the heat distribution of the atomization sheet is uniform, the atomization is uniform, and the user experience of the electronic cigarette is improved. The structure is simple, thus facilitating automatic production and reducing production cost.

### TECHNICAL FIELD

The present disclosure relates to the technical field of electronic cigarettes, in particular to an atomization sheet for an electronic cigarette and an atomizer.

### BACKGROUND

Conventionally, there are three types of atomization assemblies of electronic cigarettes. 1) A glass fiber rope or a cotton rope is inserted in a spiral heating wire as oil transfer material to transfer smoke oil to a surface of the heating wire. 2) A cotton or non-woven fabric material is wrapped outside the spiral heating wire to transfer the smoke oil to the surface of the heating wire. 3) The spiral heating wire is embedded into a porous ceramic, wherein the porous ceramic is served as oil transfer and heating material.

In the above three types of atomization assemblies, the heating wire and the oil transfer assembly are tightly assembled together in a cladding manner, the production process is complex, the cost is high, and the atomization area is small. In addition, atomizers using the above three types of atomization assemblies are complex in structure, high in cost, and not easy to assemble.

### SUMMARY

The technical problem to be solved by the present disclosure is to provide an atomization sheet for an electronic cigarette with simple structure and large atomization area and an atomizer with the atomization sheet.

The technical solution adopted by the present disclosure to solve the technical problem is to provide an atomization sheet for an electronic cigarette, which includes a sheet-shaped atomization sheet body having a surface configured to be in contact connection with a liquid transfer member, and a hole portion defined in the atomization sheet body; wherein the hole portion extends through two opposite surfaces of the atomization sheet body.

Preferably, the hole portion includes a plurality of through holes uniformly spaced distributed in the atomization sheet body.

Preferably, a center of the atomization sheet body is provided with an airflow passage hole extending through two opposite surfaces of the atomization sheet body;

the dimension of the airflow passage hole is larger than that of the through hole.

Preferably, the hole portion includes a first through hole set disposed in a center of the atomization sheet body, and two second through hole sets disposed on two opposite sides of the first through hole set;

the first through hole set includes a plurality of first through holes which are spaced distributed, and the second through hole set includes a plurality of second through holes which are spaced distributed; a hole density of the second through hole set is smaller than that of the first through hole set.

Preferably, the atomization sheet body is a woven mesh sheet; pores in the woven mesh sheet define the hole portion.

Preferably, the atomization sheet body includes a first woven mesh sheet and two second woven mesh sheets connected to two opposite ends of the first woven mesh sheet respectively; a pore density of the first woven mesh sheet is less than that of the second woven mesh sheet.

Preferably, a thickness of the atomization sheet body is 0.01 mm to 0.2 mm.

Preferably, the hole portion is filled with an insulating high-temperature-resistant porous material.

Preferably, the atomization sheet further includes connecting conductors respectively disposed at two opposite ends of the atomization sheet body.

The present disclosure further provides an atomizer for an electronic cigarette, wherein the atomizer includes the atomization sheet of any one of the above; and further includes a tubular housing, a liquid transfer member and an atomization assembly;

a liquid storage chamber and an airflow passage isolated from each other are defined in the housing; the atomization assembly is fitted on one end of the housing, the liquid transfer member and the atomization sheet are disposed between the atomization assembly and the one end of the housing, and the atomization sheet is attached to the liquid transfer member; a side surface of the atomization assembly is provided with an air inlet communicated with the airflow passage; another end of the housing is provided with an air outlet communicated with the airflow passage.

Preferably, the atomization assembly includes an atomizing seat fitted on one end of the housing, and a base fitted on one end of the atomizing seat away from the housing; the liquid transfer member is received in the atomizing seat, and the atomization sheet is disposed on the atomizing seat and is attached to the liquid transfer member.

Preferably, the atomization sheet is disposed on a surface of the atomizing seat facing the housing; or, the atomization sheet is disposed on a surface of the atomizing seat, facing the base.

Preferably, the atomizer further includes a perforated plate disposed between the atomization assembly and one end of the housing; the atomization sheet and the liquid transfer member are positioned between the perforated plate and the atomization assembly, and connecting conductors are provided on the atomization sheet and extend through the atomization assembly to be connected with a power supply of the electronic cigarette.

Preferably, the liquid storage chamber and the airflow passage are adjacently arranged along an axial direction of the housing; or, the airflow passage is located in a center of the housing, and the liquid storage chamber surrounds the airflow passage;

the atomizer further includes an air duct extending in the airflow passage; one end of the air duct extends towards the air outlet, and another end of the air duct extends to the atomization assembly.

Preferably, the atomizer further includes a suction nozzle cover fitted on another end of the housing; the suction nozzle cover is provided with a suction nozzle opening communicated with the air outlet.

The sheet-shaped atomization sheet for the electronic cigarette of the disclosure is in better contact with the liquid transfer member for liquid transfer and atomizing, and the contact area between the atomization sheet and the liquid transfer member is large, so that the atomization area is large; the resistance value of the atomization sheet is adjusted through the arrangement of the hole portion of the atomization sheet, so that the heat distribution of the atomization sheet is uniform, the atomization is uniform, and the user experience of the electronic cigarette is improved; the structure is simple, thus facilitating automatic production, and reducing the production cost.

### BRIEF DESCRIPTION OF THE DRAWINGS

The disclosure will be further described with reference to the accompanying drawings and specific embodiments. In the drawings,

FIG. 1 is a schematic structural view of an atomization sheet according to a first embodiment of the present disclosure;

FIG. 2 is a schematic structural view of an atomization sheet according to a second embodiment of the present disclosure;

FIG. 3 is a schematic structural view of an atomization sheet according to a third embodiment of the present disclosure;

FIG. 4 is a side view of the atomization sheet shown in FIG. 3;

FIG. 5 is a schematic structural view of an atomization sheet according to a fourth embodiment of the present disclosure;

FIG. 6 is a schematic structural view of an atomization sheet according to a fifth embodiment of the present disclosure;

FIG. 7 is a sectional view of an atomizer according to a first embodiment of the present disclosure;

FIG. 8 is a sectional view of an atomizer according to a second embodiment of the present disclosure;

FIG. 9 is an exploded view of the atomizer according to the second embodiment of the present disclosure;

FIG. 10 is a sectional view of an atomizer according to a third embodiment of the present disclosure;

FIG. 11 is an exploded view of the atomizer according to the third embodiment of the present disclosure.

### DETAILED DESCRIPTION

To clearly understand the technical features, objectives and effects of the disclosure, the specific embodiments of the disclosure will now be described in detail with reference to the accompanying drawings.

As shown in FIG. 1, an atomization sheet for an electronic cigarette according to a first embodiment of the present disclosure includes a sheet-shaped atomization sheet body 11 and a hole portion 12 defined in the atomization sheet body 11. In the electronic cigarette, a surface of the atomization sheet body 11 is configured for contacting with a liquid transfer member, and the contact area between the atomization sheet body 11 and the liquid transfer member is large, so that the atomization area is large and the atomization is uniform. The hole portion 12 extends through two opposite surfaces of the atomization sheet body 11. Through a specific arrangement of the hole portion 12, the resistance value of the atomization sheet can be adjusted, and liquid transfer and ventilation functions can be achieved.

The atomization sheet body 11 may be a metal sheet made of stainless steel, nickel alloy, nichrome, titanium alloy, or the like, and may be made by at least one of laser cutting, chemical etching, machining, stamping, and the like. The shape of the atomization sheet body 11 is not limited, for example, it can be a polygon, an ellipse or other shape.

The atomization sheet body 11 has a thickness of 0.01 mm to 0.2 mm.

In this embodiment, the hole portion 12 includes a plurality of through holes 121. The plurality of through holes 121 are uniformly spaced distributed in the atomization sheet body 11, and can be arranged into a plurality of rows and/or a plurality of columns, so that the whole atomization sheet is uniform in resistance value distribution, uniform in heat distribution, and uniform in atomization. The through holes 121 may be one or more of regular holes such as circular holes, polygonal holes or the like, and irregular holes.

In this embodiment, the resistance value of the atomization sheet is 0.1-0.352.

The through holes 121 of the hole portion 12 may be filled with an insulating high-temperature-resistant porous material such as ceramic as needed, to enhance the liquid transfer performance of the atomization sheet.

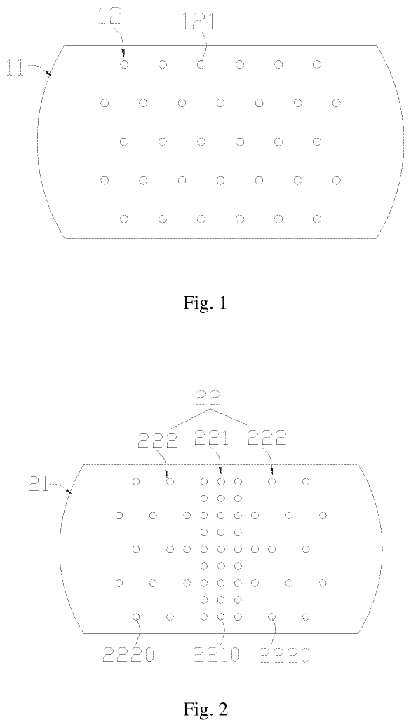

As shown in FIG. 2, an atomization sheet for an electronic cigarette according to a second embodiment of the present disclosure includes a sheet-shaped atomization sheet body 21 and a hole portion 22 defined in the atomization sheet body 21. In the electronic cigarette, a surface of the atomization sheet body 21 is configured for contacting with a liquid transfer member, and the contact area between the atomization sheet body 21 and the liquid transfer member is large, so that the atomization area is large and the atomization is uniform. The hole portion 22 extends through two opposite surfaces of the atomization sheet body 21. Through a specific arrangement of the hole portion 22, the resistance value of the atomization sheet can be adjusted, and the liquid transfer and ventilation functions can also be achieved.

The atomization sheet body 21 may be a metal sheet made of stainless steel, nickel alloy, nichrome, titanium alloy, or the like, and may be made by at least one of laser cutting, chemical etching, machining, stamping, and the like. The shape of the atomization sheet body 21 is not limited, and may be, for example, a polygonal shape, an elliptical shape, or the like.

The atomization sheet body 21 has a thickness of 0.01 mm to 0.2 mm.

In this embodiment, the hole portion 22 includes a first through hole set 221 disposed in a center of the atomization sheet body 21, and two second through hole sets 222 disposed on two opposite sides of the first through hole set 221 respectively.

The first through hole set 221 includes a plurality of first through holes 2210 distributed spaced, and the second through hole set 222 includes a plurality of second through holes 2220 distributed spaced. The hole density of the second through hole set 222 is smaller than that of the first through hole set 221, so that the distribution density of the plurality of first through holes 2210 is larger than that of the plurality of second through holes 2220, so that the heat distribution of the whole atomization sheet is uniform.

In this embodiment, the resistance value of the atomization sheet is 0.1-0.352.

The first through hole 2210 and the second through hole 2220 may be filled with an insulating high-temperature-resistant porous material such as ceramic as needed, to enhance the liquid transfer performance of the atomization sheet.

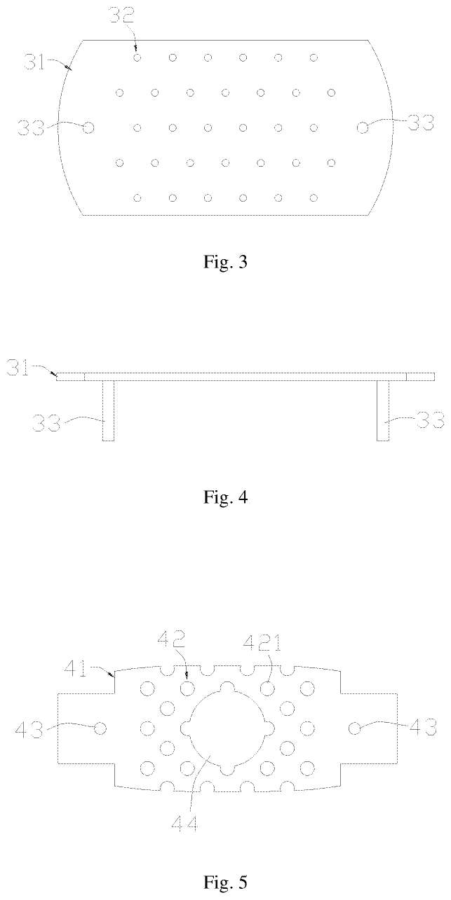

As shown in FIGS. 3 and 4, an atomization sheet for an electronic cigarette according to a third embodiment of the present disclosure includes a sheet-shaped atomization sheet body 31 and a hole portion 32 defined in the atomization sheet body 31. In the electronic cigarette, a surface of the atomization sheet body 31 is configured for contacting with a liquid transfer member, and the contact area between the atomization sheet body 31 and the liquid transfer member is large, so that the atomization area is large and the atomization is uniform. The hole portion 32 extends through two opposite surfaces of the atomization sheet body 31. Through a specific arrangement of the hole portion 32, the resistance value of the atomization sheet can be adjusted, and the liquid transfer and ventilation functions can be achieved.

The resistance value of the atomization sheet can be 0.1-0.352.

The atomization sheet body 31 may be a metal sheet made of stainless steel, nickel alloy, nichrome, titanium alloy, or the like, and may be made by at least one of laser cutting, chemical etching, machining, stamping, and the like. The shape of the atomization sheet body 31 is not limited, for example, it can be a polygon, an ellipse or other shape. The atomization sheet body 31 has a thickness of 0.01 mm to 0.2 mm.

Different from the first and the second embodiments, the atomization sheet of the present embodiment further includes connecting conductors 33 respectively disposed at two opposite ends of the atomization sheet body 31. The two connecting conductors 33 are respectively configured to be connected with a positive pole and a negative pole of a power supply in the electronic cigarette, and are conducted to supply power to the atomization sheet.

The two connecting conductors 33 are preferably disposed on a same surface of the atomization sheet body 31 to facilitate the connection of the power supply of the electronic cigarette. The connecting conductor 33 may be connected to the atomization sheet body 31 by spot welding, butt welding, soldering, laser welding, caulking, or the like.

In addition, in this embodiment, the hole portion 32 may be provided with reference to the hole portion in the first embodiment or the second embodiment described above.

As shown in FIG. 5, an atomization sheet for an electronic cigarette according to a fourth embodiment of the present disclosure includes a sheet-shaped atomization sheet body 41 and a hole portion 42 defined in the atomization sheet body 41. In the electronic cigarette, a surface of the atomization sheet body 41 is configured for contacting with the liquid transfer member, and the contact area between the atomization sheet body 41 and the liquid transfer member is large, so that the atomization area is large and the atomization is uniform. The hole portion 42 extends through two opposite surfaces of the atomization sheet body 41. Through a specific arrangement of the hole portion 42, the resistance value of the atomization sheet can be adjusted, and liquid transfer and ventilation functions can be achieved.

The atomization sheet body 41 may be a metal sheet made of stainless steel, nickel alloy, nichrome, titanium alloy, or the like, and may be made by at least one of laser cutting, chemical etching, machining, stamping, and the like. The shape of the atomization sheet body 41 is not limited, and may be, for example, a polygonal shape, an elliptical shape, or the like. The atomization sheet body 41 has a thickness of 0.01 mm to 0.2 mm.

Two opposite ends of the atomization sheet body 41 may be provided with connecting conductors 43 as needed. The two connecting conductors 43 are respectively configured for connecting with the positive pole and the negative pole of the power supply in the electronic cigarette. The connecting conductor 43 may be connected to the atomization sheet body 41 by spot welding, butt welding, soldering, laser welding, caulking, or the like.

In this embodiment, the hole portion 42 includes a plurality of through holes 421 which are uniformly spaced distributed, so that the whole atomization sheet is uniform in resistance value distribution, uniform in heat distribution, and uniform in atomization. The through holes 421 may be filled with an insulating high-temperature-resistant porous material such as ceramic as needed, so as to enhance the liquid transfer performance of the atomization sheet. A center of the atomization sheet body 41 is provided with an airflow passage hole 44 extending through two opposite surfaces of the atomization sheet body 41. The plurality of through holes 421 may surround outside the airflow passage hole 44.

The airflow passage hole 44 may be formed in the atomization sheet body 41 by punching, and a part of the through holes 421 may be punched when punching so that the part of the through holes 421 is cut to communicate with the airflow passage hole 44. The dimension of the airflow passage hole 44 is larger than that of the through hole 421. For the airflow passage hole 44 with a circular shape, the diameter of the airflow passage hole 44 is larger than the diameter of the through hole 421.

The arrangement of the airflow passage hole 44 in the atomization sheet reduces the bending times of the airflow and effectively prevents the condensation and accumulation of the smoke oil.

In this embodiment, the resistance value of the atomization sheet is 0.1-0.3Ω.

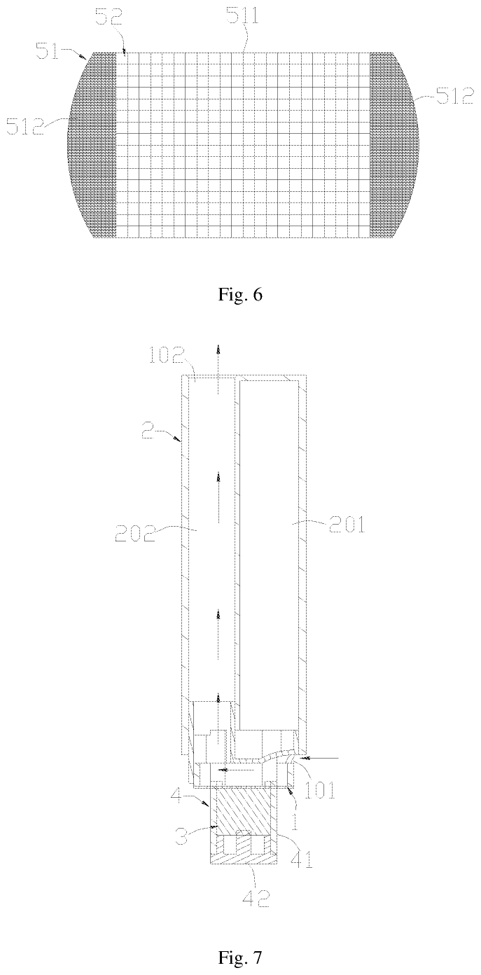

As shown in FIG. 6, an atomization sheet for an electronic cigarette according to a fifth embodiment of the present disclosure includes a sheet-shaped atomization sheet body 51 and a hole portion 52 defined in the atomization sheet body 51. In the electronic cigarette, a surface of the atomization sheet body 51 is configured for contacting with a liquid transfer member, and the contact area between the atomization sheet body 51 and the liquid transfer member is large, so that the atomization area is large and the atomization is uniform. The hole portion 52 extends through two opposite surfaces of the atomization sheet body 51. Through a specific arrangement of the hole portion 52, the resistance value of the atomization sheet can be adjusted, and the liquid transfer and ventilation functions can also be achieved.

The atomization sheet body 51 has a thickness of 0.01 mm to 0.2 mm. The shape of the atomization sheet body 51 is not limited, and may be, for example, a polygonal shape, an oval shape, or the like.

In this embodiment, the atomization sheet body 51 is a woven mesh sheet, which can be woven with conductive material such as conductive fiber. The pores in the woven mesh sheet define the hole portion 52.

Further, in this embodiment, as shown in FIG. 6, the atomization sheet body 51 includes a first woven mesh sheet 511, and two second woven mesh sheets 512 connected to two opposite ends of the first woven mesh sheet 511 respectively. The pores of the first woven mesh sheet 511 define first through holes, the pores of the second woven mesh sheet 512 define second through holes. The first through holes and the second through holes constitute the hole portion 52 of the atomization sheet.

Preferably, the pore density of the first woven mesh sheet 511 is smaller than that of the second woven mesh sheet 512, so that the density of the first woven mesh sheet 511 is different from that of the second woven mesh sheet 512, so that the optional resistance value range of the atomization sheet is wide, and the heat distribution is more uniform. The resistance value of the atomization sheet of this embodiment is 0.1-5Ω.

According to needs, the atomization sheet of this embodiment may further include connecting conductors (not shown), which are disposed at two ends of the atomization sheet body 51 respectively, for connecting with the positive pole and the negative pole of the power supply in the electronic cigarette.

As shown in FIG. 7, an atomizer according to a first embodiment of the present disclosure includes an atomization sheet 1, a tubular housing 2, a liquid transfer member 3, and an atomization assembly 4. The atomization sheet 1 may be the atomization sheet described in any one of the above embodiments.

A liquid storage chamber 201 and an airflow passage 202 isolated from each other are defined in the housing 2, for storing liquid smoke and ventilating smoke, respectively. The atomization assembly 4 is fitted on one end of the housing 2. The liquid transfer member 3 and the atomization sheet 1 are disposed between the atomization assembly 4 and the one end of the housing 2, and the atomization sheet 1 is attached to the liquid transfer member 3. A side surface of the atomization assembly 4 is provided with an air inlet 101 communicated with the airflow passage 202. Another end of the housing 2 is provided with an air outlet 102 communicated with the airflow passage 202. The air outlet 102 may form a suction nozzle.

In this embodiment, the liquid storage chamber 201 and the airflow passage 202 are disposed adjacent to each other along an axial direction of the housing 2. The atomization assembly 4 includes an atomizing seat 41 and a base 42 fitted with each other. The atomizing seat 41 is fitted on one end of the housing 2, and the base 42 is fitted on one end of the atomizing seat 41 away from the housing 2. The liquid transfer member 3 is received in the atomizing seat 41, and the atomization sheet 1 is disposed on the atomizing seat 41 and is attached to the liquid transfer member 3. The air inlet 101 may be defined in a side surface of the atomizing seat 41 or the housing 2.

The smoke liquid in the liquid storage chamber 201 can be transferred to the liquid transfer member 3, the atomization sheet 1 atomizes the smoke liquid when being electrified to generate heat, and the smoke is transferred out from the air outlet 102 of the housing 2 through the airflow passage 202.

The atomization sheet 1 can be formed on the atomizing seat 41 by means of filling, hot pressing, in-film injection molding, cotton clamping, or the like. The atomization sheet 1 can atomize the smoke liquid by means of electric heating, electromagnetic, infrared, induction, microwave, ultrasonic vibration or the like.

The atomization sheet 1 is disposed on a side of the atomizing seat 41 facing the housing 2, and the liquid transfer member 3 is adjacent to the base 42. The smoke liquid can flow to the liquid transfer member 3 through the hole portion of the atomization sheet 1 after flowing out. When a user smokes the electronic cigarette, the condensed smoke liquid generated during the smoking process can flow back to the liquid transfer piece 3 and the atomization sheet 1 for secondary utilization, thereby effectively preventing liquid leakage.

Two opposite ends of the atomization sheet 1 can extend out of the atomization assembly 4, so that when being assembled with a power supply device of the electronic cigarette, the atomization sheet 1 can be directly contacted with and electrically connected with the power supply of the power supply device.

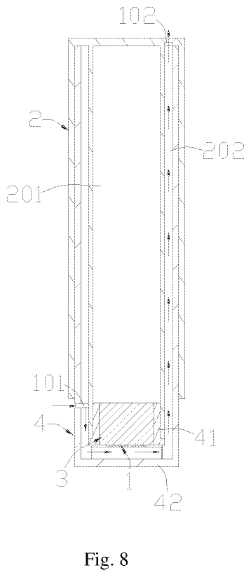

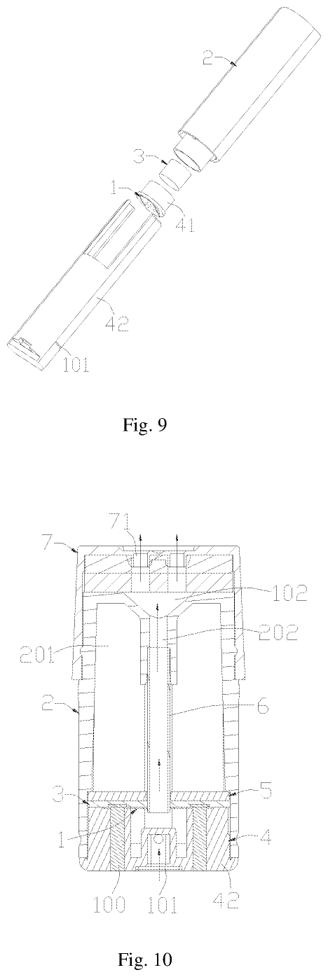

As shown in FIGS. 8 and 9, an atomizer according to a second embodiment of the present disclosure includes an atomization sheet 1, a tubular housing 2, a liquid transfer member 3, and an atomization assembly 4. The atomization sheet 1 may be the atomization sheet described in any one of the above embodiments.

A liquid storage chamber 201 and an airflow passage 202 isolated from each other are defined in the housing 2, for storing the liquid smoke and ventilating the smoke, respectively. The atomization assembly 4 is fitted on one end of the housing 2. The liquid transfer member 3 and the atomization sheet 1 are disposed between the atomization assembly 4 and the one end of the housing 2, and the atomization sheet 1 is attached to the liquid transfer member 3. A side surface of the atomization assembly 4 is provided with an air inlet 101 communicated with the airflow passage 202. Another end of the housing 2 is provided with an air outlet 102 communicated with the airflow passage 202. The air outlet 102 may form a suction nozzle.

The atomization assembly 4 includes an atomizing seat 41 and a base 42 fitted with each other. The atomizing seat 41 is fitted on one end of the housing 2, and the base 42 is fitted on one end of the atomizing seat 41 away from the housing 2. The liquid transfer member 3 is received in the atomizing seat 41, and the atomization sheet 1 is arranged on the atomizing seat 41 and is attached to the liquid transfer member 3. The smoke liquid in the liquid storage chamber 201 can be transferred to the liquid transfer member 3, the atomization sheet 1 atomizes the smoke liquid when being electrified to generate heat, and the smoke is transferred out from the air outlet 102 of the housing 2 through the airflow passage 202.

In this embodiment, the airflow passage 202 is located in the center of the housing 2, and the liquid storage chamber 201 surrounds the airflow passage 202. The atomization sheet 1 is disposed on a surface of the atomizing seat 41 facing the base 42, so as to be located below the liquid transfer member 3.

Further, in this embodiment, a side wall of the base 42 extends into the airflow passage 202 of the housing 2, and is attached to an inner wall of the housing 2, so that the airflow passage 202 is located between the side wall of the base 42 and the liquid storage chamber 201. By the extending arrangement of the side wall of the base 42 in the housing 2, the atomizing seat 41 is fitted in the base 42 and right faces to the liquid storage chamber 201, so that a space between the atomizing seat 41 and the base 42 and a space between the atomization sheet 1 and the base 42 are communicated with the airflow passage respectively. The air inlet 101 is defined in the base 41 to be communicated with the airflow passage 202.

After flowing out from the liquid storage chamber 201, the smoke liquid is directly adsorbed by the liquid transfer member 3, so that the liquid transfer is sufficient. The atomization sheet 1 located on the side of the liquid transfer member 3 facing the base 42 generates heat and atomizes the smoke liquid.

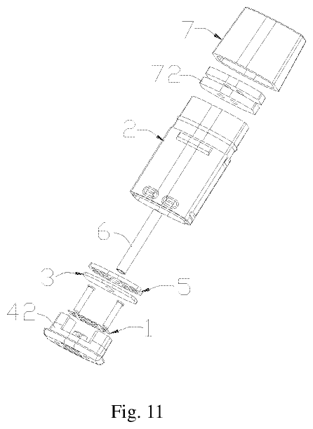

As shown in FIGS. 10 and 11, an atomizer according to a third embodiment of the present disclosure includes an atomization sheet 1, a tubular housing 2, a liquid transfer member 3, and an atomization assembly 4. The atomization sheet 1 may be the atomization sheet described in any one of the above embodiments.

A liquid storage chamber 201 and an airflow passage 202 isolated from each other are defined in the housing 2, and are respectively configured for storing the liquid smoke and ventilating the smoke. The atomization assembly 4 is fitted on one end of the housing 2. The liquid transfer member 3 and the atomization sheet 1 are disposed between the atomization assembly 4 and one end of the housing 2, and the atomization sheet 1 is attached to the liquid transfer member 3. A side surface of the atomization assembly 4 is provided with an air inlet 101 communicated with the airflow passage 202. Another end of the housing 2 is provided with an air outlet 102 communicated with the airflow passage 202. The air outlet 102 may form a suction nozzle.

In this embodiment, the airflow passage 202 is located in the center of the housing 2, and the liquid storage chamber 201 surrounds the airflow passage 202. The atomization assembly 4 includes a base 42 fitted on one end of the housing 2. The atomization sheet 1 is disposed on a surface of the base 42 facing the housing 2, and the liquid transfer member 3 is fitted on and attached to the atomization sheet 1.

The air inlet 101 is defined in the base 42 and is communicated with the airflow passage 202. After flowing out from the liquid storage chamber 201, the smoke liquid is adsorbed by the liquid transfer member 3, and the atomization sheet 1 atomizes the smoke liquid when being electrified.

Further, in this embodiment, the atomization sheet 1 is provided with connecting conductors 100. The connecting conductor 100 extends through the base 42 of the atomization assembly 4 to be connected with a power supply of the electronic cigarette. The connecting conductor 100 is connected to the atomization sheet 1 by butt welding, spot welding, caulking, laser welding, or the like.

The atomizer of this embodiment further includes a perforated plate 5 disposed between the atomization assembly 4 and one end of the housing 2. The atomization sheet 1 and the liquid transfer member 3 are located between the perforated plate 5 and the atomization assembly 4.

Furthermore, the atomizer of this embodiment further includes an air duct 6 extending in the airflow passage 202. One end of the air duct 6 extends toward the air outlet 102, and another end of the air duct 6 extends to the atomization assembly 4.

The housing 2 may be integrally formed with a suction nozzle portion, as in the embodiments shown in FIGS. 7 and 8. Alternatively, the atomize further includes a suction nozzle cover 7 fitted on another end of the housing 2. The suction nozzle cover 7 is provided with a suction nozzle opening 71 communicated with the air outlet 102.

At least one layer of suction nozzle cotton 72 can be provided between the suction nozzle cover 7 and the end of the housing 2 to effectively prevent condensed oil from being sucked into the mouth.

The atomizer disclosed by the disclosure is simple in overall assembly without threaded connection, and can be automatically produced. The atomizer can be connected with a power supply device of the electronic cigarette to form the electronic cigarette, the atomization effect is good, and the user experience is improved.

It should be understandable that the above embodiments are only preferred embodiments of the disclosure, and the description thereof is more specific and detailed, but it is not to be construed as limiting the scope of the patent of the disclosure. It should be noted that a person skilled in the art can freely combine the foregoing technical features and also can make several modifications and improvements without departing from the concept of the disclosure, and these modifications and improvements are all within the scope of protection of the present disclosure. Therefore, all equivalent transformations and modifications made according to the scope of the claims of the disclosure shall fall within the scope of the claims of the disclosure.

What is claimed is:

1. An atomization sheet for an electronic cigarette, comprising a sheet-shaped atomization sheet body having a surface configured to be in contact connection with a liquid transfer member, and a hole portion defined in the atomization sheet body; wherein the hole portion extends through two opposite surfaces of the atomization sheet body.

2. The atomization sheet according to claim 1, wherein the hole portion comprises a plurality of through holes uniformly spaced distributed in the atomization sheet body.

3. The atomization sheet according to claim 2, wherein a center of the atomization sheet body is provided with an airflow passage hole extending through two opposite surfaces of the atomization sheet body;
the dimension of the airflow passage hole is larger than that of the through hole.

4. The atomization sheet according to claim 1, wherein the hole portion comprises a first through hole set disposed in a center of the atomization sheet body, and two second through hole sets disposed on two opposite sides of the first through hole set;
the first through hole set comprises a plurality of first through holes which are spaced distributed, and the second through hole set comprises a plurality of second through holes which are spaced distributed; a hole density of the second through hole set is smaller than that of the first through hole set.

5. The atomization sheet according to claim 1, wherein the atomization sheet body is a woven mesh sheet; pores in the woven mesh sheet define the hole portion.

6. The atomization sheet according to claim 5, wherein the atomization sheet body comprises a first woven mesh sheet and two second woven mesh sheets connected to two opposite ends of the first woven mesh sheet respectively; a pore density of the first woven mesh sheet is less than that of the second woven mesh sheet.

7. The atomization sheet according to claim 1, wherein a thickness of the atomization sheet body is 0.01 mm to 0.2 mm.

8. The atomization sheet according to claim 1, wherein the hole portion is filled with an insulating high-temperature-resistant porous material.

9. The atomization sheet according to claim 1, wherein the atomization sheet further comprises connecting conductors respectively disposed at two opposite ends of the atomization sheet body.

10. An atomizer for an electronic cigarette, comprising an atomization sheet, a tubular housing, a liquid transfer member and an atomization assembly; wherein, the atomization sheet comprises a sheet-shaped atomization sheet body having a surface in contact connection with the liquid transfer member, and a hole portion defined in the atomization sheet body; the hole portion extends through two opposite surfaces of the atomization sheet body;
a liquid storage chamber and an airflow passage isolated from each other are defined in the housing; the atomization assembly is fitted on one end of the housing, the liquid transfer member and the atomization sheet are disposed between the atomization assembly and the one end of the housing, and the atomization sheet is attached to the liquid transfer member; a side surface of the atomization assembly is provided with an air inlet communicated with the airflow passage; another end of the housing is provided with an air outlet communicated with the airflow passage.

11. The atomizer according to claim 10, wherein hole portion comprises a plurality of through holes uniformly spaced distributed in the atomization sheet body.

12. The atomizer according to claim 11, wherein a center of the atomization sheet body is provided with an airflow passage hole extending through two opposite surfaces of the atomization sheet body;
the dimension of the airflow passage hole is larger than that of the through hole.

13. The atomizer according to claim 10, wherein the hole portion comprises a first through hole set disposed in a center of the atomization sheet body, and two second through hole sets disposed on two opposite sides of the first through hole set;
the first through hole set comprises a plurality of first through holes which are spaced distributed, and the second through hole set comprises a plurality of second through holes which are spaced distributed; a hole density of the second through hole set is smaller than that of the first through hole set.

14. The atomizer according to claim 10, wherein the atomization sheet body is a woven mesh sheet; pores in the woven mesh sheet define the hole portion.

15. The atomizer according to claim 14, wherein the atomization sheet body comprises a first woven mesh sheet and two second woven mesh sheets connected to two opposite ends of the first woven mesh sheet respectively; a pore density of the first woven mesh sheet is less than that of the second woven mesh sheet.

16. The atomizer according to claim 10, wherein a thickness of the atomization sheet body is 0.01 mm to 0.2 mm.

17. The atomizer according to claim 10, wherein the hole portion is filled with an insulating high-temperature-resistant porous material.

18. The atomizer according to claim 10, wherein the atomization sheet further comprises connecting conductors respectively disposed at two opposite ends of the atomization sheet body.
